(19) United States
(12) Patent Application Publication
(10) Pub. No.: US 2026/0178903 A1
(43) Pub. Date: Jun. 25, 2026

(54) TRAINING A MACHINE LEARNING MODEL FOR OBJECT DETECTION USING ENVIRONMENTAL SENSOR MEASUREMENT DATA, AND MANUFACTURING AN ENVIRONMENTAL SENSOR SYSTEM

(71) Applicant: Robert Bosch GmbH, Stuttgart (DE)

(72) Inventors: Patrick Ziegler, Waiblingen (DE); Daniel Niederloehner, Stuttgart (DE); Marco Reese, Stuttgart (DE)

(21) Appl. No.: 19/422,519

(22) Filed: Dec. 17, 2025

(30) Foreign Application Priority Data
Dec. 20, 2024 (DE) 10 2024 212 221.1

(51) Int. Cl. G06N 3/08

(52) U.S. Cl. CPC G06N 3/08

(57) ABSTRACT

A method for training a machine learning model for detecting objects using measurements from at least one environmental sensor, and method for manufacturing an environmental sensor system. Provided training data include a data segment that contains a plurality of measurements from an environmental sensor and a label set. Each measurement and each label set is assigned a time point. The label set includes at least one label that characterizes an object. Modified data are generated which include at least one measurement from at least one environmental sensor and one label set. The generating includes: predicting at least one measurement of the modified data from at least one measurement of the data segment based on a time difference and/or predicting the label set of the modified data from the label set of the data segment based on a time difference; and training the machine learning model based the generated modified data.

### CROSS REFERENCE

The present application claims the benefit under 35 U.S.C. § 119 of Germany Patent Application No. DE 10 2024 212 221.1 filed on Dec. 20, 2024, which is expressly incorporated herein by reference in its entirety.

### FIELD

The present invention relates to a method for training a machine learning model that is configured for detecting objects using measurements from at least one environmental sensor. The present invention further relates to a method for manufacturing an environmental sensor system, comprising the method for training a machine learning model that is configured for detecting objects using measurements from at least one environmental sensor.

### BACKGROUND INFORMATION

Advanced Driver Assistance Systems (ADAS) and Autonomous Driving (AD) technologies require accurate and reliable detection of the vehicle's surroundings. These systems use various sensors for this purpose, including cameras and point-based sensors such as lidar (Light Detection and Ranging) and radar (Radio Detection and Ranging). These sensors provide measured values (measurements), for example in the form of point clouds, which allow a detailed representation of the environment. For example, a lidar sensor represents each detected point by Cartesian coordinates (x, y, z) and intensity values of the reflected signal (reflection intensity). For example, a radar sensor provides polar coordinates such as distance and azimuth angle, supplemented by features such as signal strength, radar cross-section (RCS) or elevation angle. From these point clouds, environmental perception algorithms determine relevant object features such as position, orientation, extent/size and class (e.g. automobiles, trucks or pedestrians). This information is essential for safe navigation and decision-making in ADAS and AD systems.

Traditional approaches to environmental sensing combine tracking algorithms, such as Kalman filters, with downstream object type classification. Such tracking algorithms include models that describe the representation of objects in sensor data, such as reflection models for radar data or L-shaped vehicle models for lidar data.

Deep learning enables a different approach. Models in the form of artificial deep neural networks, and in particular object detection networks, can directly recognize objects and output them in the form of oriented bounding boxes (OBB), also known as bounding rectangles. These OBBs contain, for example, estimates for the probability of an object's existence, its position, orientation, extent/size, and class. The detected OBBs are then subjected to a temporal tracking algorithm.

Data augmentation is used to improve the performance of object detection models. Conventional multiplication methods for point cloud data include random spatial translation, random flipping, translation, scaling and rotation. These methods can effectively improve detection performance.

### SUMMARY

Applying machine learning methods to radar data for object detection presents a particular challenge. This is mainly due to the comparatively lower point density and the other physical properties of radar measurements, for example compared to lidar measurements.

In the event of data augmentation, capturing and emulating the actual measurement noise of a sensor presents a particular challenge.

Due to the significant effort required to create labels, it was proposed that when compiling a dataset for training, not all measurements should be considered, but rather labels should only be assigned at selected time points. For example, a data set can include labels at a rate of 2 Hz (corresponding to two label sets within a period of one second), while the reference sensors used for labeling operate or output measurement data at a rate of 10 Hz. A data set for training and validating a neural network can comprise pairs of a single label set and a corresponding single measurement. Since the sensors used for labeling and the sensors used for training are not always synchronized (e.g. a radar sensor with a cycle time of 66 ms may be used, and a lidar sensor with a cycle time of 100 ms may be used for labeling), a plurality of cycles of the sensors may be recorded before and after the frame used for labeling. The sensor measurements used during training are compared with the timestamp of the label set. The measurement with the smallest time difference is selected. The remaining measurements are discarded.

An object of the present invention is to provide an improved method for training a machine learning model for detecting objects using environmental sensor measurement data. Another object of the present invention is to provide a novel method for manufacturing an environmental sensor system, in which a machine learning model is trained for the detection of objects according to a novel method.

One or more of the objects are achieved by a method including certain features of the present invention for training a machine learning model configured for detecting objects using measurements from at least one environmental sensor, and by a method including certain features of the present invention for manufacturing an environmental sensor system. Advantageous embodiments and developments of the present invention are disclosed herein.

According to one aspect of the present invention, a method for training a machine learning model configured for detecting objects using measurements from at least one environmental sensor is provided. According to an example embodiment of the present invention, the method comprises:
providing training data comprising at least one data segment that includes a plurality of measurements from at least one environmental sensor and a label set, each of the plurality of measurements and the label set being assigned a time point, and the label set including at least one label that characterizes an object;
generating modified data comprising at least one measurement from at least one environmental sensor and a label set, based on the (provided) data segment, the generating of the modified data comprising: predicting the at least one measurement of the modified data from at least one measurement of the (provided) data segment based on a time difference and/or predicting the label set of the modified data from the label set of the (provided) data segment based on a time difference; and
training a machine learning model that is configured for detecting objects using measurement data from at least one environmental sensor, the training being based at least on the generated modified data.

The main feature of the present invention is to improve the training of an object detection model, which may be configured, for example, for processing point cloud-like data, by increasing the training data by generating further, alternative or additional assignments of labels to a measurement from existing assignments of labels to environmental sensor measurements by performing data augmentation. This allows more measurements to be used for training, while at the same time avoiding the significant additional effort required to assign extra labels. In this case, the generation of the modified data can include prediction, e.g. in the form of an adjustment (such as a temporal and/or spatial shift) of a label and/or of at least one measurement. The prediction can involve a conversion taking into account associated ego (vehicle) movement data. Existing environmental sensor measurements can be recalculated to a different time point and/or existing labels can be recalculated to a different time point. For example, modified data can be generated and used again from the provided training data in a given training period.

In particular, a new data augmentation method is thus created that uses additional measurements that are located close in time to the timestamp of the label/label set, with a time difference.

For example, according to an example embodiment of the present invention, in a step of generating a mini-batch of the training method, the measurements can be processed as follows: for a single label set, the following can be performed:
1. selecting a measurement from the associated measurements, e.g. random selection, optionally based on a predefined distribution (probability distribution);
2. matching the measurement and the time point (timestamp) of the label set to one another using prediction based on ego movement information; and
3. adding/executing further augmentation(s) (data augmentation(s)) and using them as input for training along with the given label set.

The object detection not only involves detecting objects using a single measurement, but it is also common to aggregate point clouds measured within a given time interval. The new method can be applied here accordingly. Instead of selecting a different measurement time point, a different time interval is selected.

Learning models, e.g., deep learning models, require a lot of data to be able to generalize well to unseen examples (samples). Recording and labeling data is time-consuming and expensive. Data augmentation is helpful because it can increase the variability of examples in a data set. The disclosed method can improve object detection performance and the performance of other downstream units. The reason for this is presumably that the added data are (modified) real data; this eliminates the need for time-consuming and costly additional new labels. In particular, this can improve the learning of sensor measurement noise.

According to a further aspect of the present invention, a method for manufacturing an environmental sensor system comprises: providing at least one environmental sensor; generating a machine learning model for detecting objects using measurements from the at least one environmental sensor, the generating of the machine learning model comprising: providing a machine learning model, in particular a pre-trained or untrained machine learning model, and training the provided machine learning model according to the method described herein; and providing an evaluation unit connected to the environmental sensor, which unit comprises the generated machine learning model. The provided machine learning model can be a pre-trained or untrained machine learning model.

One or more of the aforementioned aspects may include one or more of the features described below or features of one or more of the embodiments described below.

The data segment includes a plurality of measurements from at least one environmental sensor and a label set. In this case, the label set can be assigned at least one of the plurality of measurements, for example by a temporal proximity of their time points, by a coincidence of the time point of the label set and the measurement, or, e.g., by a position of the time point of the measurement relative to the time point of the label set. This measurement can be selected. For example, among the measurements with time points that are at least one time offset less than or equal to the time point of the label set, the measurement with the most recent (i.e. greatest) time point can be assigned to the label set. The time offset can in particular be zero. The data segment can correspond to a time segment (data segment-time segment), and time points assigned to the plurality of measurements and the label set of the data segment can be time points from the time segment.

When generating modified data that include at least one measurement from at least one environmental sensor and a label set, the label set can in particular be assigned to the at least one measurement. Each of the at least one measurement and the label set can be assigned a specific time point. The modified data can correspond to a time segment (prediction time segment) or a time point (prediction time point), and the time points assigned to the at least one measurement and the label set can be time points from the prediction time segment or can be the same as the prediction time point.

Thus, at least one measurement and/or one label set of the provided training data is predicted, each based on a time difference. This creates a modified measurement (predicted measurement) and/or a modified label set (predicted label set), so that new data can be used for training, which data, however, are based on the provided training data.

When predicting a measurement, a given measurement is adjusted to (or: by) the time difference (a prediction time interval), i.e., it is adjusted to a time point that results from its own measurement time, shifted by the time difference. Preferably, the prediction is made in a direction of increasing time points, i.e., in the direction of the flow of time. Each of a plurality of measurements can be adjusted by the same time difference.

In example embodiments of the present invention, the generated modified data can comprise a pair consisting of a measurement from at least one environmental sensor and a label set. The measurement can be a predicted measurement.

For example, generating the modified data may include: selecting (e.g. randomly selecting) one of the measurements from the data segment, and determining the time difference for prediction based on the selected measurement. For example, the time difference can be determined based on the time point of the selected measurement and based on a time point of the label set of the modified data, e.g., as the difference between the time point of the selected measurement and the time point of the label set of the modified data.

In example embodiments of the present invention, the generated modified data can comprise a plurality of predicted measurements of at least one environmental sensor, the generating of the modified data comprising: predicting the plurality of measurements of the modified data segment from a plurality of measurements of the data segment based on a time difference.

Thus, the plurality of predicted measurements are predicted based on the same time difference.

The time difference for predicting the measurement(s) and the time difference for predicting the label set can be the same or different.

In example embodiments of the present invention, in the case of predicting at least one measurement, the at least one relevant measurement of the modified data is assigned to a relevant time point that is earlier than or equal to the time point of the label set of the modified data.

Thus, the label set of the modified data refers exclusively to predicted measurements whose time points are less than or equal to the time point of the label set of the modified data. This makes it possible to take account of the fact that, in the later application of the trained machine learning model, for example in the operation of an environmental sensor system, the model can only access measurements that are already available at the time point of an object detection.

In example embodiments of the present invention, in the case of predicting the label set, the at least one relevant measurement of the modified data is assigned to a relevant time point that is earlier than or equal to the time point of the label set of the modified data. Thus, the predicted label set of the modified data refers exclusively to measurements whose time points are less than or equal to the time point of the predicted label set of the modified data.

In example embodiments of the present invention (especially in the case of predicting at least one measurement and/or in the case of predicting the label set), the at least one relevant measurement of the modified data is assigned to a relevant time point that is earlier than or equal to the time point of the label set of the modified data. Thus, the label set of the modified data refers exclusively to measurements whose time points are less than or equal to the time of the label set of the modified data.

In particular, if at least one measurement is predicted and the label set is predicted, the predicted label set of the modified data can refer exclusively to predicted measurements whose time points are less than or equal to the time point of the predicted label set of the modified data.

In example embodiments of the present invention, in the case of predicting at least one measurement, the at least one relevant measurement of the data segment used to predict the at least one measurement of the modified data is assigned to a relevant time point that is temporally earlier than or equal to the time point of the label set of the modified data. In other words, a time point of a measurement used for prediction is less than or equal to a time point of the label set of the modified data.

Therefore, prediction relies exclusively on measurements whose time points are less than or equal to the time point of the label set of the modified data. Therefore, prediction relies exclusively on measurements that could have already been measured at the time point of the label set of the modified data (according to their assigned time points). However, it is also possible to use measurements from the future for prediction. That is, at least one relevant measurement of the data segment used to predict (back-project) at least one measurement of the modified data can be assigned to a relevant time point that is later in time than the time point of the label set of the modified data.

The time point of the label set of the modified data can be smaller (earlier) than the time point of the label set of the data segment, equal to the time point of the label set of the data segment, or larger (later) than the time point of the label set of the data segment.

In the case of predicting a label set, the time point of the predicted label set can be less (earlier) or greater (later) than the time point of the label set of the data segment.

In example embodiments of the present invention, the time difference when predicting the at least one measurement, or the time difference when predicting the label set, or the relevant time difference is less than or equal to 500 ms, preferably less than or equal to 400 ms, more preferably less than or equal to 300 ms, particularly preferably less than or equal to 250 ms.

This leads to particularly realistic predictions of measurements and/or label sets, since within such a period the further development of a traffic event can be predicted with a high degree of probability and with near realism. For stationary targets, prediction, in particular an adjustment to a prediction time point according to the time difference, can be carried out without error. Experiments performed have shown that if the time difference from the (temporally) closest measurement time point is chosen to be sufficiently small, e.g. 150 ms to 250 ms, the error of a predicted measurement (obtained by adjustment) is still acceptable and a training process of a machine learning model for object detection can benefit from the training data increased in this way, even for moving targets.

The training data can comprise a plurality of such data segments, for each of which the steps of generating modified data and training are performed.

In example embodiments of the present invention, the training data comprise a plurality of data segments, each comprising a plurality of measurements from at least one environmental sensor and a label set, each of the plurality of measurements and the label set being assigned a time point, and the label set comprising at least one label that characterizes an object, the step of generating modified data being performed for each of the plurality of data segments, the generating of modified data being based on the relevant data segment in each case, and the training of the machine learning model being based at least on the respective modified data generated.

In this case, for example, modified data from a plurality of data segments can be combined into a batch, and this batch can then be used to train the model.

Different or for example randomly selected time differences can be used in each case for each data segment for the relevant prediction.

A random selection of a time difference can be achieved in particular by randomly selecting one measurement from the plurality of measurements of the data segment. In particular, the time difference can then be determined by the difference between the time point of the measurement and the time point of the label set.

The step of generating modified data for the plurality of data segments can be carried out, in the event of predicting the at least one measurement, in each case with a different relevant time difference (or a randomly selected relevant time difference) for predicting the at least one measurement, and/or the step of generating modified data for the plurality of data segments can be carried out, in the event of predicting the label set, in each case with a different relevant time difference (or a randomly selected relevant time difference) for predicting the label set.

In some example embodiments of the present invention, the relevant time difference is randomly selected from values within an interval. The time interval preferably has an absolute value of less than or equal to 500 ms, more preferably less than or equal to 400 ms, more preferably less than or equal to 300 ms, and particularly preferably less than or equal to 250 ms.

After performing training based on the plurality of data segments (corresponding, for example, to a training period), the generating of the modified data and the training can be repeated (corresponding, for example, to another training period), it being possible for a different or for example randomly selected time difference to be used for each data segment.

Thus, the steps of generating modified data and training can be performed repeatedly; in each iteration of the steps of generating modified data and training for the same data segment, different respective time differences (or randomly selected respective time differences) being used in each case, for predicting the at least one measurement in the case of predicting the at least one measurement, and/or different respective time differences (or randomly selected respective time differences) being used for predicting the label set in the case of predicting the label set.

In each iteration of the training step, the training for respective data segments (or for modified data based on respective data segments) can be performed in different sequences of the data segments (assigned to the modified data). Thus, in different training periods, the modified data based on the data segments can be trained in different sequences.

According to an example embodiment of the present invention, the method can include: splitting the training data into the respective data segments.

For training purposes, a plurality of measurements of predicted data can be aggregated.

Thus, in embodiments, the generated modified data comprise a plurality of (e.g. predicted) measurements from at least one environmental sensor, the method further comprising: aggregating the plurality of (e.g. predicted) measurements of the generated modified data into an aggregated measurement from at least one environmental sensor, and the training being based on at least the generated modified data comprising the aggregated measurement. This allows the model to be provided with modified data containing a higher number of measurements. The relevant time point of the predicted measurements can be preserved during aggregation.

Aggregating a plurality of measurements can be done before predicting or generating the modified data.

Thus, in example embodiments of the present invention, the data segment comprises a plurality of measurements from at least one environmental sensor, the method further comprising: aggregating the plurality of measurements of the data segment into an aggregated measurement of at least one environmental sensor, and the generating of modified data being based on the aggregated measurement and the label set of the data segment, the modified data comprising the aggregated measurement from at least one environmental sensor and a label set, the generating of the modified data comprising: predicting the at least one measurement of the modified data from the aggregated measurement of the data segment based on a time difference, and/or predicting the label set of the modified data from the label set of the data segment based on a time difference.

In example embodiments of the present invention, the machine learning model is an artificial neural network, in particular an object detection network for detecting objects using measurements from at least one environmental sensor.

The machine learning model can be configured to receive environmental sensor measurements as input, process them, and calculate an output. In embodiments, the machine learning model is configured to output at least one bounding box, the bounding box identifying each detected object. The output can include a set of bounding boxes. The set can include at least one bounding box. In the case of a relevant detected extended object, the output can specify a relevant bounding box of the detected extended object. In the case of a plurality of detected extended objects, the output may include a plurality of bounding boxes.

The measurements may include, in particular, radar measurements and/or lidar measurements.

The environmental sensor measurements can include, in particular, point cloud-like measurements, for example points in the form of reflections, detections or locations. In the case of a plurality of detected points, the point cloud-like measurements can be structured according to points, for example they can include a list of points or a point cloud.

In example embodiments of the present invention, the measurements from at least one environmental sensor, in the case of a plurality points detected by one environmental sensor, comprise point clouds or point lists whose points correspond to the respective detected points.

In example embodiments of the present invention, the machine learning model is configured for detecting objects using measurements from at least one radar sensor, the at least one data segment comprising a plurality of measurements from at least one radar sensor.

The relevant label set of a data segment can correspond to an object situation (e.g., traffic situation) embodied by at least one of the measurements of the data segment.

A given label can, in particular, characterize features of an object, including its probability of existence, size or extent, an angle such as an elevation angle, a position or coordinates, an orientation and/or a class of the object. Each label can, in particular, include a description of an object in the form of an oriented bounding box (OBB).

In the case of a plurality of objects (i.e. in the case of a plurality of objects being characterized by the label set), the label set comprises a plurality of labels, each label characterizing features of the relevant object. A label set is assigned a label set time point (a timestamp).

The training data can describe at least one coherent scene (of a traffic event), in particular a scene of a traffic event in the vicinity of an ego vehicle. The scene can include a plurality of the data segments.

The measurements from at least one environmental sensor can originate from at least one environmental sensor of an ego vehicle or be assigned to at least one environmental sensor of an ego vehicle.

The data segment of the training data may also include ego movement data, in particular ego vehicle movement data (movement data of the ego vehicle). The respective ego movement data can be assigned to respective ego time points. The ego time point can correspond to a measurement time point (time point of a measurement) or a label (set) time point (time point of a label set). The ego movement data can include: speed, acceleration and/or yaw rate of the ego vehicle.

According to an example embodiment of the present invention, the modified data can include ego movement data, in particular ego movement data (or the ego movement data) of the data segment.

The method may further include: changing the measurements and the label set of a data segment or the modified data generated based on a data segment, the changing including at least one of: truncating the at least one measurement and the label set, (spatially) shifting the at least one measurement and the label set, (spatially) flipping or mirroring the at least one measurement and the label set, e.g. with respect to a coordinate axis or a coordinate (e.g. a Cartesian coordinate), scaling the at least one measurement and the label set, and rotating the at least one measurement and the label set. This allows the detection performance of the trained model to be further improved. The changing can be carried out before the modified data are generated, the modified data then being generated based on the changed data. The changing can be performed after the modified data have been generated, the modified data then being changed. The originally provided training data can be retained and provided again for further training periods.

In the following, example embodiments are explained in more detail with reference to the figures.

### BRIEF DESCRIPTION OF EXAMPLE EMBODIMENTS

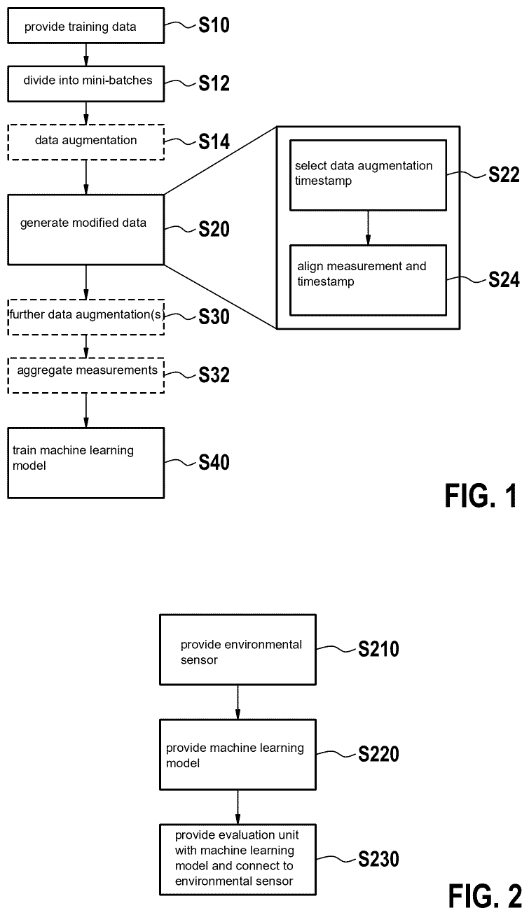

FIG. 1 is a schematic representation of a training method for a machine learning model, according to an example embodiment of the present invention.

FIG. 2 is a schematic representation of a method for manufacturing an environmental sensor system, according to an example embodiment of the present invention.

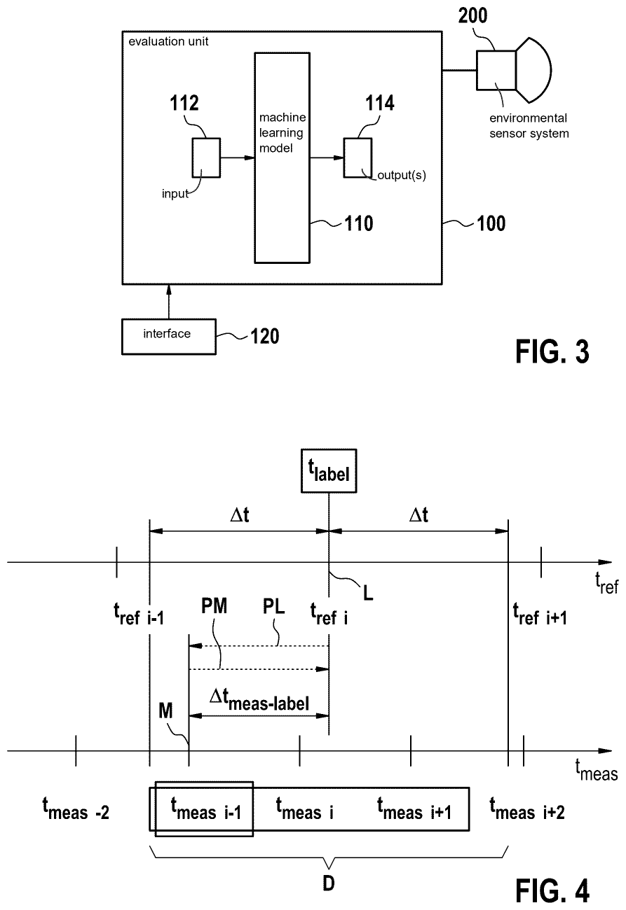

FIG. 3 is a schematic representation of the environmental sensor system with an evaluation unit that includes the machine learning model, according to an example embodiment of the present invention.

FIG. 4 is a schematic representation of a data segment of training data, as well as modified data with a predicted label set or a predicted measurement, according to an example embodiment of the present invention.

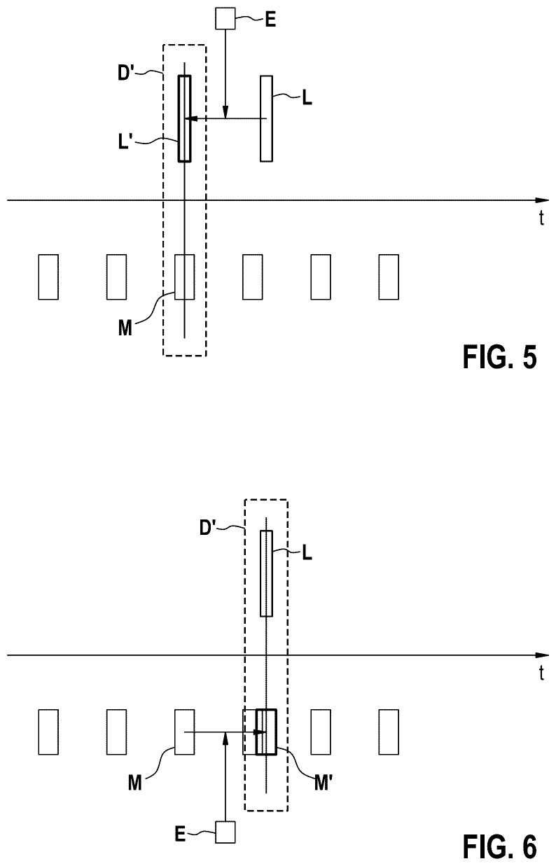

FIG. 5 is a schematic representation of a data segment of training data, as well as modified data with a predicted label set, according to an example embodiment of the present invention.

FIG. 6 is a schematic representation of a data segment of training data, as well as modified data with a predicted measurement, according to an example embodiment of the present invention.

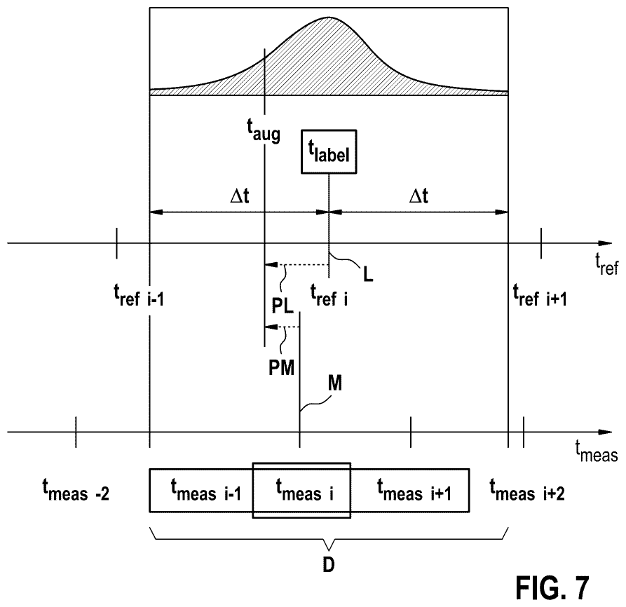

FIG. 7 is a schematic representation of a data segment of training data, as well as modified data with a predicted label set and a predicted measurement, according to an example embodiment of the present invention.

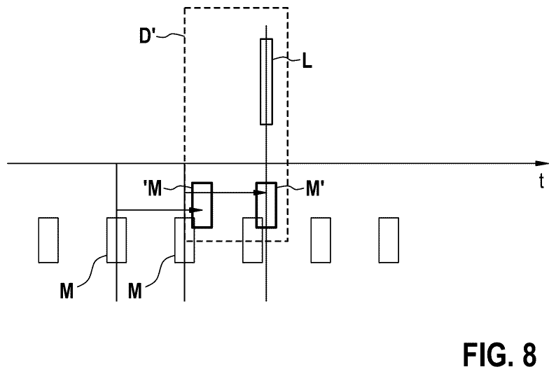

FIG. 8 is a schematic representation of a data segment of training data, as well as modified data with a plurality of predicted measurements, according to an example embodiment of the present invention.

### DETAILED DESCRIPTION OF EXAMPLE EMBODIMENTS

FIG. 1 schematically shows an example of a training method for a machine learning model for the detection of objects using measurements from an environment sensor, FIG. 2 is a schematic representation of a method for manufacturing an environment sensor system, and FIG. 3 is a schematic representation of the environment sensor system with an environment sensor 200 in the form of a radar sensor, and with an evaluation unit 100 which includes the machine learning model 110. In order to manufacture the environmental sensor system, the environmental sensor 200 is provided (step S210), the machine learning model 110 is provided in a pre-trained or untrained state and trained according to the training method (step S220), and the evaluation unit 100, with the machine learning model 110 implemented therein, is provided and connected to the environmental sensor 200 (step S230).

The training method can be structured as follows: training data are provided (step S10) which (as shown for example in FIG. 4) contain measurements M of a radar sensor, which is, for example, identical in construction to the environmental sensor 200. The training data also contain label sets L, each of which can contain a number of labels.

The training data can also be shuffled in step S10, i.e. the sequence of data segments of the training data can be changed, for example changed randomly.

The training data are then divided into mini-batches of the same size in step S12. Each mini-batch contains, for example, 16 to 256 data segments D (samples). Each data segment D contains a plurality of measurements M. The measurements M have respective time points t_{meas i}. Each data segment D also contains a label set L, which has a time point t_{ref i}.

Optionally, the respective data segments undergo data augmentation (step S14), for example random cropping, flipping or rotating.

Modified data D′ are then generated from the relevant data segment (step S20). This is explained in more detail below.

Optionally, and as an alternative to step S14, the respective modified data undergo data augmentation (step S30), for example random cropping, flipping or rotating.

Then the training (step S40) of the machine learning model 110 takes place. For this purpose, the corresponding measurements for the respective modified data D′ are entered as input 112 into the model 110, and error gradients are determined based on the corresponding label sets from the outputs 114. The gradients are averaged over the mini-batch, and the model parameters are updated using an optimization algorithm such as SGD (stochastic gradient descent).

Steps S20, possibly S14 or S30, and S40 are repeated for all mini-batches of training data, and the model parameters are updated after each mini-batch.

Once all mini-batches have been processed, a training period is complete, and the method is repeated starting from step S10 for the next period, until the model converges.

FIG. 4 illustrates examples of generating (S20) the modified data D′. tref denotes the times of the labels and can correspond to the timestamps of a reference sensor among the sensors used for labeling, tmeas denotes the times of the measurements M. A data segment D, also called a label frame, is defined according to a time interval tmeas−Δt≤tLabel≤tmeas+Δt around the timestamp tLabel of the label set L. For each label set L, there are therefore a plurality of associated measurements M.

In a first variant, the following steps are performed for a single label set L or a single data segment D:
1. A measurement is randomly selected from the interval tmeas−Δt≤tLabel≤tmeas+Δt (step S22). The selection can optionally be based on a probability distribution, for example a uniform distribution or a categorical distribution with a maximum at the labeling time point tLabel. The parameter Δt, the type of distribution and the parameters thereof are then hyperparameters of the training and can be set together with the other parameters.
2. The measurement M and the timestamp of the label set L are aligned (step S24) using ego movement data E, to account for changes in the measurement or labels due to movement in the environment. This can be done:
a) by means of prediction (PL) of the label set L (around the time difference Δtmeas-label) on the timestamp of the measurement M (e.g. using the time difference, the ego movement state and the speed of a relevant label); this is illustrated separately in FIG. 5; or
b) by means of prediction (PM) of the measurement M (around the time difference Δtmeas-label) on the timestamp of the label set L (e.g. using the time difference and the ego movement state); this is illustrated separately in FIG. 6.
3. Further data augmentations (augmentation method) can optionally be performed (step S30).

The environmental sensor system can access the ego movement data E via an interface 120, for example by accessing data from an ESP system.

FIG. 7 illustrates another example of generating (S20) the modified data D′.

In a second variant, the following steps are performed for a single label set L or a single data segment D:
1. A data augmentation timestamp (time point) is selected from the interval tmeas−Δt≤tLabel≤tmeas+Δt (step S22), based on a probability distribution (e.g. a uniform distribution or a normal distribution with a mean tLabel=and e.g. Sigma=150 ms). The parameter Δt, the type of distribution and the parameters thereof are then hyperparameters of the training and can be set together with the other parameters.
2. The measurement M and the timestamp of the label set L are aligned (step S24) using ego movement data E, to account for changes in the measurement or labels due to movement in the environment. In contrast to the first variant, both the measurement M and the label set L are predicted. This can be done by:
a) selecting, for example, the measurement M that is closest in time to the prediction time point (data augmentation timestamp) taug, and predicting the measurement M at the prediction time point taug, (e.g. using the relevant time difference and the ego movement state); and
b) predicting the measurement M at the prediction time point taug (e.g. using the relevant time difference and the ego movement state).
3. Further data augmentations (augmentation method) can optionally be performed (step S30).

The first variant allows a fixed number of possible data-augmented states (modified data) per label set. The second variant has the advantage of further increased variability in the training data, since the selected value of the prediction time point taug is continuous and the number of possible data-augmented states is not limited.

Predicting measurements can be performed well for point cloud data such as radar data (reflections or locations) and lidar data, since the positions of the individual measurement points can be shifted according to the ego movement of the ego vehicle.

FIG. 8 illustrates an embodiment in which a plurality of measurements M are predicted. The modified data D′ comprise a plurality of predicted measurements and a label set L. The training method may include aggregating the plurality of measurements M (step S32). The aggregation can also be included in step S20 of generating the modified data. In the case of aggregation, the mixing does not take place in step S10, but rather the modified data D′ are mixed only after augmentation, for example in step S32 after aggregation.

Experiments on a training data set (e.g., Bosch LH5-2019) have shown that the training method disclosed herein is advantageous in addition to existing data augmentation methods. These experiments used a Δt for sampling (selecting) 250 ms and a uniform distribution for selecting the samples. Ten training sessions were evaluated for each method. The results shown in Table (1) indicate the average precision (mean AP) in percent and the corresponding standard deviations (SD):

TABLE 1

| | Mean AP | Mean AP | Mean AP | Mean AP |
|---|---|---|---|---|
| | Passenger | Truck | Bicycle | Pedestrian |
| | Car (SD) | (SD) | (SD) | (SD) |
| Traditional data | 24.66 | 17.82 | 11.65 | 5.43 |
| augmentation | (0.33) | (0.57) | (1.04) | (0.47) |
| Additional | 25.43 | 18.58 | 13.11 | 5.81 |
| prediction with | (0.23) | (0.66) | (1.54) | (0.38) |
| Δt selection | | | | |

What is claimed is:

1. A method for training a machine learning model that is configured for detecting objects using measurements from at least one environmental sensor, the method comprising the following steps:
providing training data including at least one data segment that includes a plurality of measurements from at least one environmental sensor and a label set, wherein each of the plurality of measurements and the label set is assigned a time point, and wherein the label set includes at least one label that characterizes an object;
generating modified data including at least one measurement from at least one environmental sensor and a label set based on the data segment, wherein the generating of the modified data includes: (i) predicting the at least one measurement of the modified data from at least one measurement of the data segment based on a time difference and/or (ii) predicting the label set of the modified data from the label set of the data segment based on a time difference; and
training a machine learning model that is configured for detecting objects using measurement data from at least one environmental sensor, wherein the training is based on at least the generated modified data.

2. The method according to claim 1, wherein the generated modified data include a pair including a measurement from at least one environmental sensor and a label set.

3. The method according to claim 1, wherein the generated modified data include a plurality of predicted measurements from at least one environmental sensor, wherein the generating of the modified data includes: (i) predicting the plurality of measurements of the modified data segment from a plurality of measurements of the data segment based on a time difference.

4. The method according to claim 1, wherein the at least one relevant measurement of the modified data is assigned to a relevant time point which is earlier in time than or equal to the time point of the label set of the modified data.

5. The method according to claim 1, wherein when predicting the at least one measurement, an at least one relevant measurement of the data segment used to predict the at least one measurement of the modified data is assigned to a relevant time point which is earlier in time than or equal to the time of the label set of the modified data.

6. The method according to claim 1, wherein the time difference is less than or equal to 500 ms.

7. The method according to claim 1, wherein:
the training data include a plurality of data segments, each including a plurality of measurements from at least one environmental sensor and a label set, wherein each of the plurality of measurements and the label set is assigned a time point, and wherein the label set includes at least one label that characterizes an object,
wherein the step of generating modified data is carried out for each respective data segment of the plurality of data segments, wherein the generating of modified data includes generating respective modified data based on the respective data segment, and wherein the training of the machine learning model is based at least on the respective generated modified data,
wherein: (i) the step of generating modified data for the plurality of data segments is performed, in the case of predicting the at least one measurement, in each case with a different relevant time difference or with a randomly selected relevant time difference for predicting the at least one measurement, and/or (ii) the step of generating modified data for the plurality of data segments is performed, in the case of predicting the label set, in each case with a different relevant time difference or with a randomly selected relevant time difference for predicting the label set.

8. The method according to claim 1, wherein the steps of generating the modified data and training are performed repeatedly, wherein in each iteration of the steps of generating modified data and training for the same data segment different respective time differences or randomly selected respective time differences are used for predicting the at least one measurement in the case of predicting the at least one measurement and/or different respective time differences or randomly selected respective time differences are used for predicting the label set in the case of predicting the label set.

9. The method according to claim 1, wherein:
the generated modified data include a plurality of measurements from at least one environmental sensor,
the method further include: aggregating the plurality of measurements of the generated modified data into an aggregated measurement of at least one environmental sensor, and
the training is based at least on the generated modified data including the aggregated measurement.

10. The method according to claim 1, wherein:
the data segment includes a plurality of measurements from at least one environmental sensor,
the method further includes: aggregating the plurality of measurements of the data segment into an aggregated measurement of at least one environmental sensor, and
the generating of modified data is based on the aggregated measurement and the label set of the data segment, wherein the modified data include the aggregated measurement of at least one environmental sensor and a label set, wherein the generating of the modified data includes: (i) predicting the at least one measurement of the modified data from the aggregated measurement of the data segment based on a time difference and/or predicting the label set of the modified data from the label set of the data segment based on a time difference.

11. The method according to claim 1, wherein the machine learning model is an artificial neural network which includes an object detection network for detecting objects using measurements from at least one environmental sensor.

12. The method according to claim 1, wherein the machine learning model is configured to output a set of bounding boxes, wherein the bounding boxes each characterize a detected object.

13. The method according to claim 1, wherein the machine learning model is configured for detecting objects using measurements from at least one radar sensor, wherein the at least one data segment includes a plurality of measurements from at least one radar sensor.

14. The method according to claim 1, wherein the measurements from at least one environmental sensor include a plurality of points detected by one environmental sensor, and include point clouds or point lists, points of the point clouds or point lists correspond to the respective detected points.

15. A method for manufacturing an environmental sensor system, the method comprising:
providing at least one environmental sensor;
generating a machine learning model for detecting objects using measurements from the at least one environmental sensor, wherein the generating of the machine learning model includes: providing a pre-trained or untrained machine learning model, and training the provided machine learning model by:
providing training data including at least one data segment that includes a plurality of measurements from at least one environmental sensor and a label set, wherein each of the plurality of measurements and the label set is assigned a time point, and wherein the label set includes at least one label that characterizes an object,
generating modified data including at least one measurement from at least one environmental sensor and a label set based on the data segment, wherein the generating of the modified data includes: (i) predicting the at least one measurement of the modified data from at least one measurement of the data segment based on a time difference and/or (ii) predicting the label set of the modified data from the label set of the data segment based on a time difference, and
training the provided machine learning model that is configured for detecting objects using measurement data from at least one environmental sensor, wherein the training is based on at least the generated modified data; and
providing an evaluation unit connected to the environmental sensor, the evaluation unit including the generated machine learning model.
